(19) United States
(12) Patent Application Publication
(10) Pub. No.: US 2015/0228137 A1
(43) Pub. Date: Aug. 13, 2015

(54) WIRELESS ACCESS CONTROL TO A LOCKING DEVICE

(71) Applicant: Chongqing Terminus Science and Technology Co. Ltd., Chongqing (CN)

(72) Inventors: Wanxing Chen, Shapingba District (CN); Jianjun Chen, Shapingba District (CN); Xiang Wang, Shapingba District (CN)

(73) Assignee: CHONGQING TERMINUS SCIENCE AND TECHNOLOGY CO. LTD., Chongqing (CN)

(21) Appl. No.: 14/617,443

(22) Filed: Feb. 9, 2015

Related U.S. Application Data
(60) Provisional application No. 61/965,731, filed on Feb. 7, 2014.

(51) Int. Cl. G07C 9/00

(52) U.S. Cl. CPC G07C 9/00309; G07C 9/00142; G07C 2009/00325; G07C 9/00904; G07C 2009/00753

(57) ABSTRACT

Systems and methods for controlling a locking device over a short-range wireless radio frequency. The system comprises an intelligent user terminal and a locking device, and authorizes access based at least upon information received at a user interface of the locking device and authorization data transmitted to the locking device by the intelligent user terminal. The methods comprise receiving an access request at a locking device, configuring the locking device to establish a connection to the intelligent user terminal, establishing the connection, and authorizing the intelligent user terminal based on authorization data.

### BACKGROUND

Access control systems are commonly found in hotels, apartments, commercial buildings, hospitals, exhibition halls, conference rooms, and the like to provide security and reduce management costs by preventing unauthorized access to designated areas. In its simplest form, an access control system comprises a mechanical door lock and a corresponding key. Physical keys for use with mechanical locks, however, can be easily misplaced, stolen, copied, or otherwise compromised, which not only inconveniences the user but creates a serious security concern. Electronic access control systems replace the traditional lock and key with an electronic device for receiving credentials presented by a user seeking access. Typical devices include keypads, card readers, and biometric scanners.

Unfortunately, typical devices are subject to several shortcomings. For example, many existing systems require a hard wired power supply instead of battery power. Even if the device relies on battery power, the battery life of the device may limit the functionality of the system. Further, these systems are subject to interruption or failure during power outages. Additionally, existing systems are difficult to install and initialize; setting up the access control system and matching the locking device with a device used to gain access is time intensive and complicated, requiring many hours of labor by a skilled professional. Also, present systems use less secure methods to authenticate the devices used to gain access, such as a personal identification number (PIN). A need exists to provide an access control system with improved reliability, extended battery life, and more secure means of authentication.

### SUMMARY

Briefly, aspects of the present invention relate to the field of access control, and more particularly to systems and methods for securing access to locking devices over short-range wireless radio frequencies.

In an aspect, an access control system controls a locking device over a short-range wireless radio frequency. The access control system comprises an intelligent user terminal configured to transmit authorization data related to secure access. The access control system also includes a locking device comprising a user interface configured to receive user input and a communication module configured to communicate with the intelligent user terminal according to a short-range wireless communication protocol. The communication module receives the authorization data transmitted from the intelligent user terminal when they are connected. In addition, the access control system includes a controller configured to approve the intelligent user terminal for secure access based upon establishing a connection between the communication module and the intelligent user terminal and in response to the authorization data received by the communication module. The controller is also configured to operate in an active state in response to the user input received by the user interface.

In another aspect, a method for authorizing secure access control of a locking device over a short-range wireless radio frequency is provided. The locking device receives an access request at a user interface, is configured to establish a connection between a controller in the locking device and an intelligent user terminal, and establishes the connection. The controller receives authorization data from the intelligent user terminal through the established connection and generates information related to an authorization status of the intelligent user terminal based on the received authorization data.

In yet another aspect, another method for authorizing secure access control of a locking device over a short-range wireless radio frequency is provided. An access request is transmitted to a user interface of a locking device. Responsive to the transmitted access request, confirmation is received that the locking device is configured to establish a connection between the locking device and an intelligent user terminal, and the connection is established. Authorization data is transmitted to the control device through the established connection. The authorization date comprises at least one of a physical address code, an unlock password, and a mobile phone number uniquely identifying the communication module of the intelligent user terminal. And data is processed related to the authorization status of the intelligent user terminal based on the transmitted authorization data for indicating the intelligent user terminal has been authorized as an authorized user terminal.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Other features will be in part apparent and in part pointed out hereinafter.

### BRIEF DESCRIPTION OF THE DRAWINGS

FIG. 1 is a block diagram depicting a system for controlling secure access to a locking device over a short-range wireless radio frequency according to one embodiment of the invention.

FIG. 2 depicts a partial circuit diagram comprising components of the locking device 56 in accordance with aspects of the present invention.

FIG. 3 is a diagram of a power management system according to one embodiment of the present invention.

FIG. 4 is a flow chart depicting a method of providing access control to a locking device by authorizing an intelligent user terminal using a USB key interface according to another embodiment of the present invention.

FIG. 5 is a flow chart depicting a method of providing access control to a locking device by authorizing an intelligent user terminal using information related to an authorized user terminal according to another embodiment of the present invention.

Corresponding reference characters indicate corresponding parts throughout the drawings.

### DETAILED DESCRIPTION

Aspects of this invention relate to hardware and software components used to control access, and more specifically, to components configured to improve the functionality of access control over short range radio frequencies.

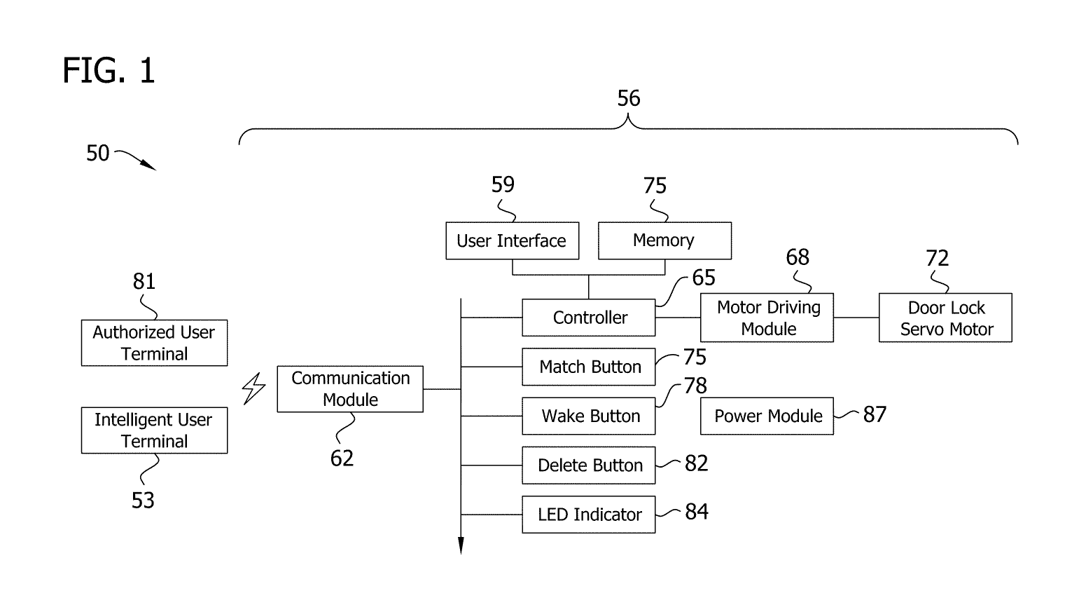

Turning to FIG. 1, an access control system for controlling a locking device over a short-range wireless radio frequency is generally depicted at 50. The system 50 includes an intelligent user terminal 53 configured to transmit authorization data related to authorizing secure access, and a locking device 56. In an embodiment, the intelligent user terminal 53 comprises a mobile device such as a smart phone. The locking device 56 further comprises a user interface 59 configured to receive user input, a communication module 62 configured to communicate with the intelligent user terminal 53 according to a short-range wireless communication protocol, and a controller 65 configured to approve the intelligent user terminal 53 for secure access based upon establishing a connection between the communication module 62 and the intelligent user terminal 53 and in response to the authorization data received by the communication module 62. In an embodiment, the short-range wireless protocol comprises BLUETOOTH protocol. In an embodiment, the system components are compatible with BLUETOOTH v2.0, BLUETOOTH v3.0, and BLUETOOTH v4.0.

With further reference to FIG. 1, in an embodiment, the communication module 62 receives authorization data transmitted from the intelligent user terminal 53 when connected to the intelligent user terminal 53. Additionally or alternatively, the authorization data is composed of information that uniquely identifies the communication module of the intelligent user terminal 53. Advantageously, the uniquely identifying information assists in expediting the authorization of secure access, and increases the security of the authorization process.

The communication module 62 of the locking device 56 comprises, for example, a BLUETOOTH short range wireless module. Additionally or alternatively, the communication module of the intelligent user terminal 53 also comprises a BLUETOOTH short range wireless module. In a further embodiment, the communication module of the intelligent user terminal 53 is a BLUETOOTH short range wireless module capable of identification by a physical address code associated with the module. In an embodiment, the physical address code comprises a BLUETOOTH short range wireless address, which is understood by one having ordinary skill in the art to comprise a hexadecimal address string of 12 alphanumeric characters capable of uniquely identifying the BLUETOOTH short range wireless device of the intelligent user terminal 53.

The user interface 59 in one embodiment includes a USB key interface configured to accept a USB key as part of the authorization process. Further, with the incorporation of a USB key, the user interface 59 receives user input provided by the USB key interface. The intelligent user terminal 53 in turn initiates the transmission of authorization data when the USB key is activated. Additionally, the controller 65 further comprises a motor driving module 68 communicatively connected to a door lock servo motor 72. The door lock servo motor 72 is advantageously configured to receive control signals provided by the controller 65 to operate a lock in response to short-range wireless radio. In an embodiment, in response to receiving a short range wireless signal, the controller 65 first verifies the received signal. After the received signal is verified, the controller 65 operates the door lock servo motor 72 to unlock the door.

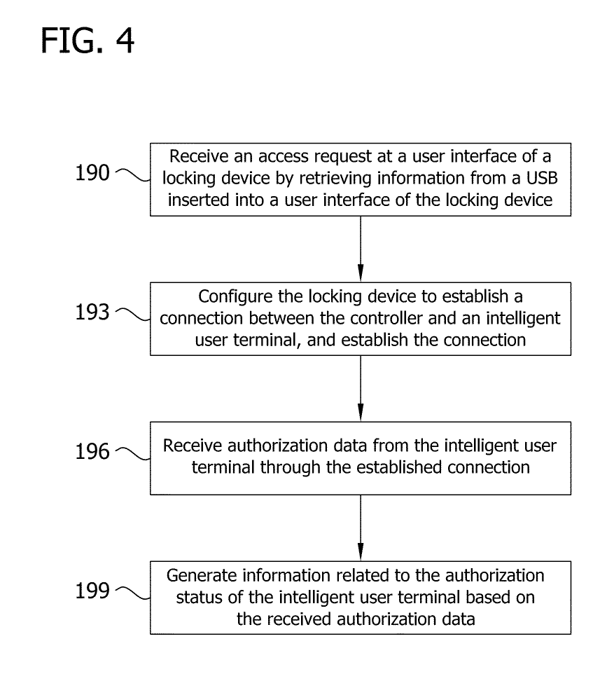

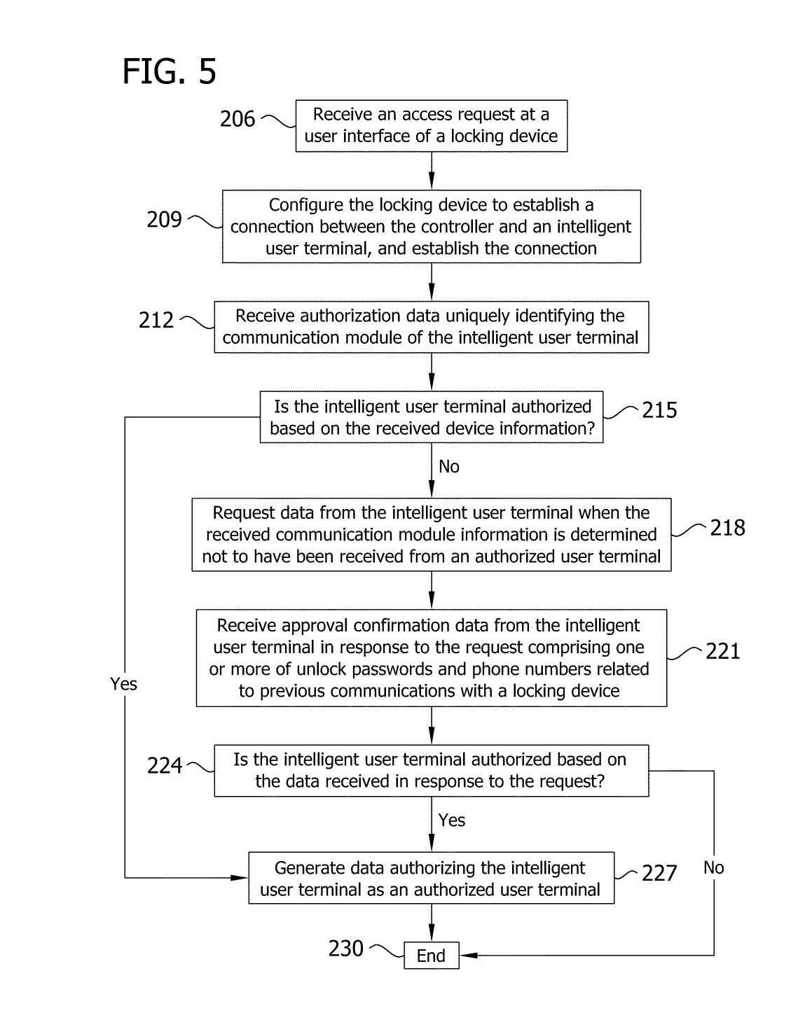

In an embodiment, the locking device 56 is configured to establish a connection between the controller 65 and the intelligent user terminal 53 as will be described in further detail below with reference to FIG. 4 and FIG. 5. In an embodiment, establishing a connection between the controller 65 and the intelligent user terminal 53 comprises pairing the controller 65 to a smartphone via BLUETOOTH. The controller 65 additionally comprises computer readable memory 75. In an embodiment, the computer readable memory 75 comprises EEROM memory. Additionally, the controller 65 is further configured to store one or more of the following in the computer readable memory 75: device information related to the communication module 62, an unlock password, a mobile phone number related to an intelligent user terminal 53, and a mobile phone number related to an authorized user terminal 81.

Additionally or alternatively, the controller 65 is further configured to store an access log in the computer readable memory 75. In an embodiment, the access log includes operation details of the locking device 56. In an embodiment, the operation details include physical address codes and time-stamped authorization data associated with communication modules of intelligent user terminals 53, and communication modules of authorized user terminals 81. In an embodiment, the authorized user terminal 81 comprises a cellular phone, and the access log records data related to phone number of the authorized cell phone. Those having ordinary skill in the art understand that by recording physical address codes and time-stamped authorization data, a log of successful and unsuccessful attempts at accessing the locking device 56 are recorded for later access. In a further embodiment, the access log includes a time period for which an intelligent user terminal 53 can be authorized as an authorized user terminal 81. Additionally or alternatively, the access log includes data comprising at least one of the following: the number of times the authorized user terminal 81 can be used to open the lock, a password associated with the authorized user terminal 81, and details pertaining to the method used for approving an intelligent user terminal 53 for secure access. In an embodiment, the access log records data related to unauthorized attempts to access the locking device 56.

In an embodiment, the controller 65 executes computer executable instructions for approving an intelligent user terminal 53 for secure access, as will be described in further detail below with reference to FIG. 4 and FIG. 5. The controller 65 is capable of being configured to operate in an active state and in an energy saving state. Additionally, when the locking device 56 is accessed by an authorized user terminal 81, the controller 65 is capable of being configured to exit the energy saving state and to transition to the active state. In an embodiment, the controller completes the transition to the active state in response to at least one of the following communications provided by an authorized user terminal 81: an instant message, an email, or a phone call. Advantageously, transitioning to the active state in response to communications provided by an authorized user terminal 81 increases convenience to the user by providing alternative means of access control.

Various buttons are envisioned for placement on the locking device 56 that are capable of being configured to operate in accordance with aspects of the present invention. In one non-limiting example, the locking device 56 further comprises a “Match” button 75 on the user interface 59 for configuring the controller 65 to operate using a password as will be described in further detail with reference to FIG. 4 and FIG. 5. Additionally or alternatively, a “Wake” button 78 is placed on the locking device 56 and is capable of configuring the controller 65 to initiate the active state in response to operation of the “Wake” button 78. In an embodiment, the locking device 56 further comprises a “Delete” button 82 capable of configuring the controller 65 to delete all information saved on the computer readable memory 75, such as information related to an authorized user terminal 81, or information related to an intelligent user terminal 53. Additionally, the locking device 56 comprises an LED indicator circuit 84 capable of outputting authentication information and unlocking instructions during the process of authorizing secure access.

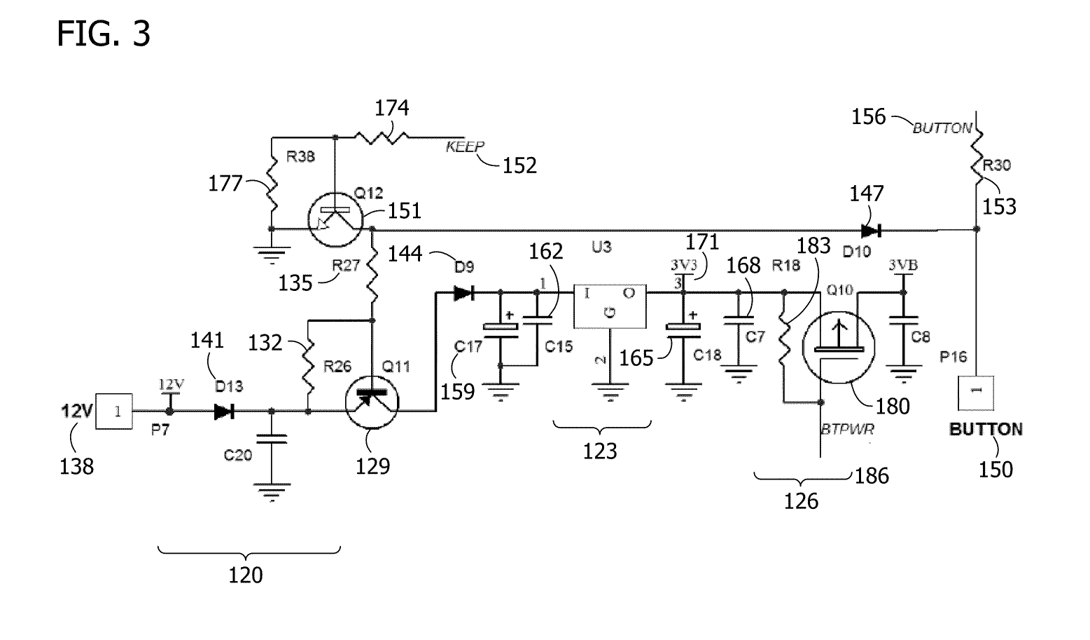

With further reference to FIG. 1, the locking device 56 additionally or alternatively comprises a power module 87 configured to provide power to the locking device 56 without the need for a hard wired power connection. In an embodiment, the power module 87 is connected to the controller 65 via a power management sub-circuit. As will be described in further detail with reference to FIG. 3, the power management sub-circuit generally depicted in FIG. 3 is capable of being configured to selectively provide power from the power module 87 to the controller 65 during the active state. In an embodiment, the power management sub-circuit generally depicted in FIG. 3 is configured to selectively provide power from the power module 87 to the controller 65 during the active state based upon at least one of: controller 65 timing signals, an access request from an authorized user terminal 81, and operation of the “Wake” button 78. In an embodiment, the power management sub-circuit generally depicted in FIG. 3 is configured to operate in the energy saving state when not in the active state. In an embodiment, the “Wake” button 78 comprises a mechanical “Wake” switch. In an embodiment, the “Wake” button 78 allows access to the locking device 56 in the event an intelligent user terminal 53 or an authorized user terminal 81 is not operational due to low battery power. By providing access control using the system described above, greater convenience is provided to the user, and management of the locking device 56 is simplified. These principles apply whether the system is solely based on mechanical components, or whether electronic devices are incorporated.

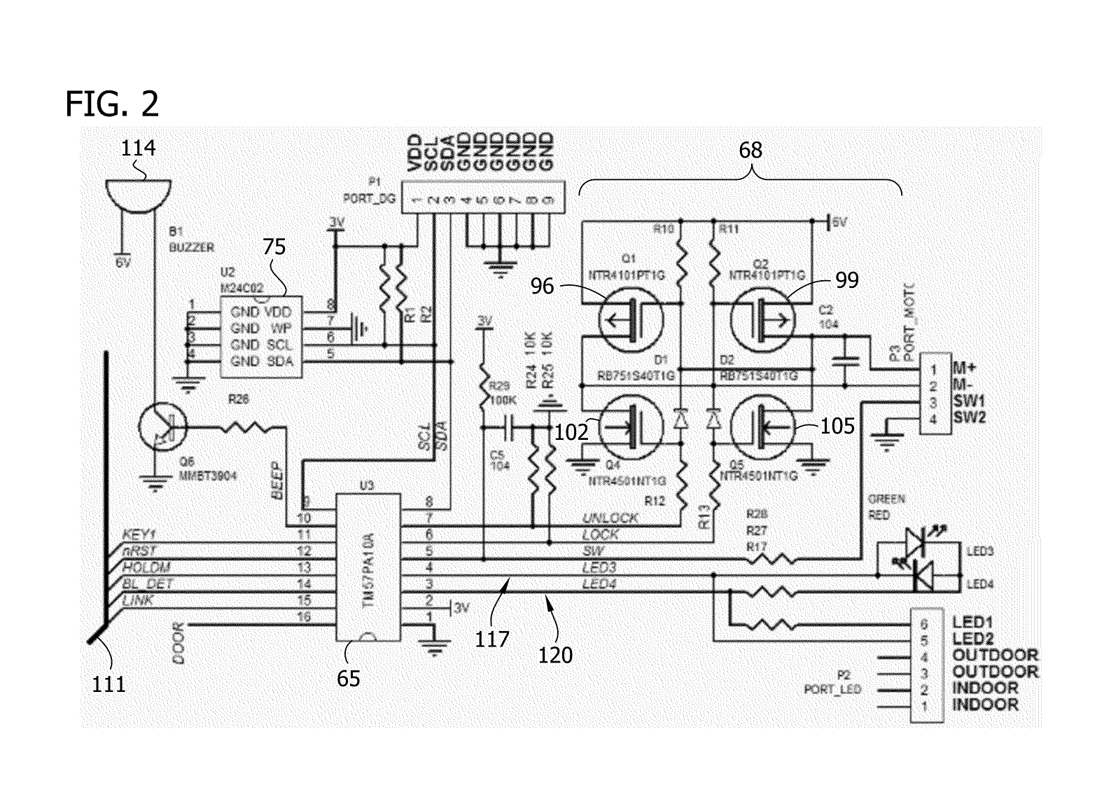

FIG. 2 depicts a partial circuit diagram comprising components of the locking device 56 in accordance with aspects of the present invention. The components of the locking device 56 include, in one embodiment, a controller 65 and a motor driving module 68. In an embodiment, the controller 65 comprises an 8-bit single chip microcomputer such as TM57PA10 manufactured by Tenx Technology, Inc. Further, the motor driving module 68 comprises MOSFET switches Q1 90, Q2 93, Q4 96, and Q5 99. The controller 65 controls the motor driving module 68 to drive the servo motor 71 such that the servo motor 71 can run clockwise or counterclockwise to lock or unlock a door. Advantageously, in an embodiment, the controller 65 provides signals to drive the motor driving module 68 based upon short-range wireless radio signals provided by an intelligent user terminal 53. Additionally or alternatively, the controller 65 provides signals to drive the motor driving module 68 based upon short-range wireless radio signals provided by an authorized user terminal 81.

With further reference to FIG. 2, the locking device 56 further comprises a computer readable memory 75. In an embodiment, the computer readable memory 75 further comprises the M24C02 EEROM memory manufactured by STMicroelectronics. Additionally or alternatively, the “Match” button 75 and the “Wake” button 78 are connected between an output of the power module 87 and a BUS 111 to provide pulse signals. In one non-limiting example, the “Match” button 75 and the “Wake” button 78 are configured to provide different signals to at least one of: a buzzer 114, a first LED indicator circuit 117, and a second LED indicator circuit 120.

Advantageously, the system described above allows for secure access to be accepted locally by matching the information in a USB key with the controller 65 of a locking device 56 that makes up part of an access control mechanism (in a door, for example) through unlocking authentication in an intelligent user terminal 53. In an embodiment, after the intelligent user terminal 53 receives unlocking authentication, the intelligent user terminal 53 itself becomes an authorized user terminal 81. Further, following authorization of an intelligent user terminal 53 as an authorized user terminal 81, at least one of BLUETOOTH short range wireless device information, an unlock password, and a mobile phone number are sent to the controller 65 for local storage on the computer readable memory 75. In this manner, greater convenience is provided to the user and management of the system is simplified by improvements related to the intelligent user terminal 53 which serves as the “key”, by simplifying the process necessary to authenticate the intelligent user terminal 53.

Alternatively, authentication may be accomplished by remote authorization, by authorizing an intelligent user terminal 53 using information related to an authorized user terminal 81. Instead of matching information in a USB key, authentication information related to the authorized user terminal 81 is received and evaluated by the locking device 56. In an embodiment, if the intelligent user terminal 53 is determined to be authorized based on the received data, approval confirmation data is stored on the intelligent user terminal 53 requiring authentication, to authorize access to the intelligent user terminal 53.

FIG. 3 is a diagram of a power management system according to one embodiment of the present invention. In an embodiment, the power management system includes a circuit comprising a power input interface 120, a voltage regulator module 123 and a power output interface 126. In an embodiment, a first electronic switch 129 is connected between the power input interface 120 and the voltage regulator module 123, and the output of the voltage regulator module 123 connects with power output interface 126. The power output interface 126 is configured to provide power to the controller 65. In an embodiment, the drive end of the first electronic switch 129 is connected with the power input interface 120 via a resistor R26 132. In an embodiment, the drive end of the first electronic switch 129 is also associated with one end of resistor R27 135.

With further reference to FIG. 3, 12V DC power 138 is provided to the first electronic switch 129 via the power input interface 120. In an embodiment, the first electronic switch 129 is a PNP transistor, and includes a diode D13 141. Additionally, the collector of the first electronic switch 129 connects to the input terminal of the voltage regulator module 123 via a diode D9 144. Further, resistor R26 132 is connected between the emitter and base of the first electronic switch 129, and the base of the first electronic switch 129 is connected to one terminal of resistor R27 135. A diode D10 147 connects in series between the resistor R27 135 and a mechanical switch 150. In an embodiment, the mechanical switch 150 is a push button switch, which connects to the controller 65 via a resistor R30 153, to transmit a switching signal to the controller 65, and the other end of R27 135 is grounded via the mechanical switch 150 and a second electronic switch 151. Additionally or alternatively, the second electronic switch 151 receives signals to sustain the power supply from an output of the controller 65. In an embodiment, the output of the controller is transmitted to the second electronic switch 151 via a KEEP pin 152. In an embodiment, a BUTTON pin 156 and the input and output terminals of the voltage regulator module 123 are filtered by connections to filter capacitors C17 159, C15 162, C18 165, and C7 168.

In one non-limiting example further describing the structure and function of the power management sub-circuit depicted in FIG. 3, 12V DC power 138 is converted to 3.3V DC power by the output pin 171 of the voltage regulator module 123. This 3.3V DC output power supplies the power for the controller 65. The second electronic switch 151 is an NPN transistor Q12 in one embodiment. Additionally, the collector of the second electronic switch 151 is connected to a resistor 135, and the emitter of the second electronic switch 151 is grounded. A resistor 174 limits the current transmitted to the base electrode of the second electronic switch 151. In an embodiment, the resistor 174 receives a signal as an output from the controller 65 to sustain the power supply via the KEEP pin 152, and a resistor R38 177 is also connected between the base and the emitter of the second electronic switch 151.

Further describing the above non-limiting example, the source output of the voltage regulator module 132 is connected to the gate of a MOS transistor Q10 180. In an embodiment, the drain of the MOS transistor Q10 provides a second power output port. Additionally, a resistor R18 183 is connected between the source and the gate of MOS transistor Q10 180 to supply power to other chip modules. Further, MOS transistor Q10 180 converts 3.3V DC to 3V output to drive a communication module 62.

With further reference to FIG. 3, in an embodiment, the MOS transistor Q10 180 facilitates operation of the locking device 56 in an energy saving state by using the gate of the MOS transistor Q10 180 to output an interrupt signal to the controller 65 via a BTPWR pin 186. In an embodiment, the sub-circuit of FIG. 3 facilitates power management by operating the first electronic switch 129 to control the power input from the voltage regulator module 123. In an embodiment, the first electronic switch 129, the controller 65, and other modules are powered-off during the energy saving state. In an embodiment, operating the mechanical switch 150 connects resistor 135 to ground, causing the voltage measured at the emitter of the first electronic switch 129 to increase.

In an embodiment, increasing the voltage at the emitter of the first electronic switch 129 energizes the voltage regulator module 123, causing the controller 65 to operate in an active state. The controller 65 receives an interrupt signal from the BTPWR pin 186 while operating in the active state, and provides signals via the KEEP pin 152 according to the internal mechanisms provided by the controller 65 to maintain power to the base of the second electronic switch 151, and the second electronic switch 151 maintains a ground connection at resistor R27 132. The controller 65 is further configurable to cut off the output provided to the KEEP pin 152 if the locking device 56 does not operate within a predetermined period of time. In an embodiment, cutting off power to the KEEP pin 152 disconnects the base resistor 135 from ground, which in turn disconnects the first electronic switch 129, causing the locking device 56 to operate in an energy saving state.

Advantageously, the sub-circuit of FIG. 3 allows for the operation of a locking device 56 in an energy saving mode. In an embodiment, upon a successful pairing between an authorized user terminal 81 and a locking device 56, the locking device 56 operates in active mode. In an embodiment, the secure access authorization system is operated by battery, and the low energy consumed during the idle mode allows for the system to last more than two years without needing to replace the battery. As described above, allowing the locking device 56 to function in a low power state extends the operational life of the battery providing power to the locking device 56, making the device more convenient for a user.

FIG. 4 is a flow chart depicting a method of operating a locking device 56 according to one embodiment of the present invention. The method depicted in FIG. 4 describes providing access control to a locking device 56 by authorizing an intelligent user terminal 53 using a USB key interface according to another embodiment of the present invention. In an embodiment, establishing a connection between the locking device 56 and the intelligent user terminal 53 comprises pairing the controller 65 to a smartphone via BLUETOOTH. As previously described, the locking device 56 is capable of authorizing access over a short-range wireless radio frequency. In an embodiment, a controller 65 is configured to operate the locking device 56 in response to authorized secure access. The process begins at 190, where an access request is received at a user interface 59 of the locking device 56. Receiving an access request additionally comprises retrieving information from a USB key inserted into the user interface. At 193, the locking device 56 is configured to establish a connection between the controller 65 and an intelligent user terminal 53, and the connection is established. Next, at 196, authorization data is received from the intelligent user terminal 53 through the established connection. Finally, the process ends at 199, where information is generated related to the authorization status of the intelligent user terminal 53 based on the received authorization data.

FIG. 5 is a flow chart depicting a method of providing access control to a locking device by authorizing an intelligent user terminal 53 using information related to an authorized user terminal 81 according to another embodiment of the present invention. The process described by FIG. 5 begins at 206, where an access request at a user interface 59 of a locking device 56 is received. In an embodiment, receiving an access request comprises receiving an indication that a “Wake” button 78 on the user interface 59 has been pressed. The process continues at 209, where the locking device 56 is configured to establish a connection between the controller 65 and the intelligent user terminal 53, and the connection is established. Additionally, authorization data is provided via the connection. At 212, authorization data is received that uniquely identifies the communication module of the intelligent user terminal 53. In an embodiment, the uniquely identifying authorization data comprises a physical address code of a BLUETOOTH short range wireless device expressed as a string of 12 alphanumeric hexadecimal characters.

In an embodiment, information related to the authorization status of the intelligent user terminal 53 is generated based on the received uniquely identifying information. The process continues at 215 where, if the intelligent user terminal 53 is authorized based on the received device information, data is generated authorizing the intelligent user terminal 53 as an authorized user terminal 81, and the process ends at 227. In an embodiment, if the intelligent user terminal 53 is not authorized based on the received device information, the process continues at 218, where data is requested from the intelligent user terminal 53.

At 221, approval confirmation data is received from the intelligent user terminal 53 in response to the request, including unlock passwords and phone numbers related to previous communications with a locking device. In an embodiment, the locking device 56 from which the approval confirmation data is received is the locking device 56 to which the intelligent user terminal 53 is currently connected for authentication. In an embodiment, the locking device from which the approval confirmation data is received is different from the locking device 56 to which the intelligent user terminal 53 is currently connected for authentication.

In a further embodiment, the approval confirmation data comprises an authorization code including one or more of the following: a cellular phone number related to the owner of the locking device 56, a physical address code related to the owner of the locking device 56, a cellular phone number related to an authorized user terminal 81, data related to the number of times an authorized user terminal 81 can be used to access the locking device 56, the time period during which the authorized user terminal 81 is authorized to access the locking device 56, and a password associated with the authorized user terminal 81. In an embodiment, encryption methods are used to protect the authorization code. In a further embodiment, the authorization code is communicated using one or more of the following: short-range wireless radio frequencies, and application software executed by an authorized user terminal 81.

At 224, a determination is made as to whether the intelligent user terminal 53 is authorized based on the data received in response to the request. If the intelligent user terminal 53 is not authorized, the process ends at 230. If the intelligent user terminal 53 is authorized, data is generated at 227 authorizing the intelligent user terminal 53 as an authorized user terminal 81, and the process ends at 230.

In an embodiment, configuring the locking device 56 to establish a connection comprises operating the door lock servo motor 72 in the manner described herein, wherein the controller 65 is configured to operate in an active state to unlock a door using the door lock servo motor 72 and configured to operate in an energy saving state when the controller 65 is not in the active state. In an embodiment, the active state is initiated by at least one of: accessing the locking device 56 using an authorized user terminal 81; operating the “Wake” button 78 on the locking device 56; and receiving one or more of an instant message, an email, and a phone call from an authorized user terminal 81. In the manner described above, aspects of the present invention provide advantages over known short-range wireless access control systems which require that the authentication of previously unverified devices such as intelligent user terminals 53 be accomplished using less secure methods. For example, known systems require a code to be provided from the device such as a personal identification number (PIN); if the code is compromised, the system becomes less secure. By providing additional or alternative methods of secure device authentication as described above, security is improved when compared to known systems. Further, by providing additional ways to allow access to the locking device 56 in the event the authorized user terminal 81 is out of power, further advantages over known short-range wireless access control systems are provided.

In an embodiment, the locking device 56 is accessed by requesting data comprising password set-up information from the authorized user terminal 81, receiving data in response to the request, storing the data in a computer readable memory 75 within the locking device 56, and requesting password information data from the intelligent user terminal 53. Additionally or alternatively, accessing the locking device 56 comprises receiving an indication that a “Match” button 75 on the locking device 56 has been pressed. The controller 65 is configurable to operate in the active state to unlock a door using the servo motor 72 when data received in response to the request for password information data matches password set-up information data. Receiving data in response to the request comprises executing application software on the authorized user terminal 81 to prompt a user to key in the password. In an embodiment, the data received in response to the request is transmitted by pressing the soft keyboard of the authorized user terminal 81. Additionally or alternatively, the data received in response to the request is transmitted by pressing the “Wake” button 78.

Known access control systems do not provide for an efficient means of establishing a password after an intelligent user terminal 53, such as a mobile device or smartphone, is authorized. Further, known systems do not provide a user with a means for alternative access in the event an authorized user terminal 81, such as a mobile device or smartphone, runs low on battery power. Also, known systems do not provide a user with a means for access to an access control system as described above in the event the short-range wireless system is dysfunctional. By providing the features described above, the present invention presents improvements over known systems.

In an embodiment, a password is stored in the computer readable memory 75, and application software is executed on the authorized user terminal 81 to prompt a user that the process was successful. In an embodiment, operation of the “Wake” button 78 on the locking device 56 for a period of time results in a prompt to provide a password. Additional or alternative means are available for prompting the user to provide a password. In one non-limiting example, an LED indicator circuit 84 initiates the prompt. In another non-limiting example, a buzzer 114 initiates the prompt. In an embodiment, after the user provides the password, and the controller 65 determines whether the password matches with the pre-setup password saved in the computer readable memory 75, an indication that the password is a match is provided by a green LED light energized by the LED indicator circuit 84, and the controller 65 operates the motor driving module 68 and the door lock servo motor 72 to open the door lock. Additionally or alternatively, the indication is provided by a buzzer 114. Further, following a mismatch, an indication that the password is incorrect is provided by the LED indicator circuit 84. In a further embodiment, an alarm is provided by the LED indicator circuit 84 in the event an incorrect password is entered a predetermined number of times. Additionally or alternatively, the alarm is provided by the buzzer 114.

Embodiments of the aspects of the invention may be described in the general context of data and/or processor-executable instructions, such as program modules, stored one or more tangible, non-transitory storage media and executed by one or more processors or other devices. Generally, program modules include, but are not limited to, routines, programs, objects, components, and data structures that perform particular tasks or implement particular abstract data types. Aspects of the invention may also be practiced in distributed computing environments where tasks are performed by remote processing devices that are linked through a communications network. In a distributed computing environment, program modules may be located in both local and remote storage media including memory storage devices.

In operation, processors, computers and/or servers may execute the processor-executable instructions (e.g., software, firmware, and/or hardware) such as those illustrated herein to implement aspects of the invention.

Embodiments of the aspects of the invention may be implemented with processor-executable instructions. The processor-executable instructions may be organized into one or more processor-executable components or modules on a tangible processor readable storage medium. Aspects of the invention may be implemented with any number and organization of such components or modules. For example, aspects of the invention are not limited to the specific processor-executable instructions or the specific components or modules illustrated in the figures and described herein. Other embodiments of the aspects of the invention may include different processor-executable instructions or components having more or less functionality than illustrated and described herein.

The order of execution or performance of the operations in embodiments of the aspects of the invention illustrated and described herein is not essential, unless otherwise specified. That is, the operations may be performed in any order, unless otherwise specified, and embodiments of the aspects of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that several advantages of the aspects of the invention are achieved and other advantageous results attained.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively or in addition, a component may be implemented by several components.

The above description illustrates the aspects of the invention by way of example and not by way of limitation. This description enables one skilled in the art to make and use the aspects of the invention, and describes several embodiments, adaptations, variations, alternatives and uses of the aspects of the invention, including what is presently believed to be the best mode of carrying out the aspects of the invention. Additionally, it is to be understood that the aspects of the invention is not limited in its application to the details of construction and the arrangement of components set forth in the following description or illustrated in the drawings. The aspects of the invention are capable of other embodiments and of being practiced or carried out in various ways. Also, it will be understood that the phraseology and terminology used herein is for the purpose of description and should not be regarded as limiting.

Having described aspects of the invention in detail, it will be apparent that modifications and variations are possible without departing from the scope of aspects of the invention as defined in the appended claims. It is contemplated that various changes could be made in the above constructions, products, and process without departing from the scope of aspects of the invention. In the preceding specification, various preferred embodiments have been described with reference to the accompanying drawings. It will, however, be evident that various modifications and changes may be made thereto, and additional embodiments may be implemented, without departing from the broader scope of the aspects of the invention as set forth in the claims that follow. The specification and drawings are accordingly to be regarded in an illustrative rather than restrictive sense.

The Abstract is provided to help the reader quickly ascertain the nature of the technical disclosure. It is submitted with the understanding that it will not be used to interpret or limit the scope or meaning of the claims.

What is claimed is:

1. An access control system for controlling a locking device over a short-range wireless radio frequency, the system comprising:
an intelligent user terminal configured to transmit authorization data related to secure access; and
a locking device, said locking device comprising:
a user interface configured to receive user input;
a communication module configured to communicate with the intelligent user terminal according to a short-range wireless communication protocol, said communication module receiving the authorization data transmitted from the intelligent user terminal when connected thereto; and
a controller configured to approve the intelligent user terminal for secure access based upon establishing a connection between the communication module and the intelligent user terminal and in response to the authorization data received by the communication module, said controller further configured to operate in an active state in response to the user input received by the user interface.

2. The system of claim 1, further comprising a USB key, and wherein:
the user input received by the user interface is provided by a USB key interface; and
the intelligent user terminal initiates the transmission of authorization data when the USB key is activated.

3. The system of claim 1, wherein the controller executes computer-executable instructions for approving the intelligent user terminal for secure access, said instructions comprising:
determining an authorization status of the intelligent user terminal based on the authorization data transmitted from the user terminal;
generating data approving the intelligent user terminal when the received authorization data is determined to have been received from an authorized user terminal;
requesting approval confirmation data from the intelligent user terminal when the received authorization data is determined not to have been received from an authorized user terminal; and
approving the intelligent user terminal as an authorized user terminal based on the approval confirmation data received in response to the request, the approval confirmation data comprising one or more of an unlock password and a phone number related to previous communications with the locking device.

4. The system of claim 1, wherein the controller is further configured to operate in an active state and in an energy saving state.

5. The system of claim 4, wherein the controller exits the energy saving state and initiates the active state in response to operation of a “Wake” button on the locking device.

6. The system of claim 4, wherein the controller exits the energy saving state and initiates the active state in response to the locking device being accessed via an authorized user terminal;

7. The system of claim 4, wherein the controller exits the energy saving state and initiates the active state in response to at least one of an instant message, an email, or a phone call from an authorized user terminal.

8. The system of claim 4, further comprising a power management sub-circuit configured to selectively provide power from a power module to the controller during the active state based upon at least one of: controller timing signals, access requests from authorized user terminals, and operation of a mechanical “Wake” switch, and configured to operate in the energy saving state when not in the active state.

9. The system of claim 1, wherein the controller further comprises an EEROM memory, and wherein the controller is further configured to store one or more of the following in the EEROM memory as authorization data: communication module device information, an unlock password, and a mobile phone number.

10. The system of claim 1, wherein the communication module device information comprises physical address codes of the communication module and wherein the controller is further configured to store an access log in the EEROM memory, said access log including the physical address codes and time-stamped authorization data associated therewith.

11. A method for authorizing secure access control of a locking device over a short-range wireless radio frequency, the locking device having a controller configured to operate the locking device in response to authorized secure access, the method comprising:
receiving an access request at a user interface of the locking device;
responsive to the received access request, configuring the locking device to establish a connection between the controller and an intelligent user terminal via a short-range wireless communication protocol, and establishing the connection;
receiving, by the controller, authorization data from the intelligent user terminal through the established connection; and,
generating, by the controller, information related to an authorization status of the intelligent user terminal based on the received authorization data.

12. The method of claim 11, wherein receiving the access request comprises retrieving information from a USB key inserted into the user interface.

13. The method of claim 11, wherein receiving the access request comprises receiving an indication that a “Wake” button on the locking device has been pressed.

14. The method of claim 11, wherein the authorization data comprises information uniquely identifying a communication module of an intelligent user terminal, and wherein generating information related to the authorization status of the intelligent user terminal comprises:
determining the authorization status of the intelligent user terminal based on the received uniquely identifying information;
generating data authorizing the intelligent user terminal as an authorized user terminal when the received uniquely identifying information is determined to have been received from an authorized user terminal;
requesting data from the intelligent user terminal when the received uniquely identifying information is determined not to have been received from an authorized user terminal;
receiving approval confirmation data from the intelligent user terminal in response to the data request, wherein the received approval confirmation data comprises one or more of unlock passwords and phone numbers related to previous communications with a locking device; and,
authorizing the intelligent user terminal as an authorized user terminal based on the approval confirmation data received in response to the request.

15. The method of claim 14, wherein configuring the locking device to establish a connection further comprises operating a door lock servo motor communicatively connected to the controller via a motor driving module, wherein the controller is configured to operate in an active state to unlock the door using the servo motor and configured to operate in an energy saving state when the controller is not in the active state.

16. The method of claim 15, further comprising initiating the active state in response to one or more of the following: accessing the locking device using an authorized user terminal; operating a “Wake” button on the locking device; and receiving one or more of an instant message, an email, and a phone call from an authorized user terminal.

17. The method of claim 16, wherein accessing the locking device comprises:
requesting data comprising password set-up information from the authorized user terminal;
receiving data in response to the request and storing the data in an EEROM memory within the locking device; and
requesting password information data from the intelligent user terminal.

18. The method of claim 16, wherein accessing the locking devices comprises receiving an indication that a “Match” button on the locking device has been pressed, and wherein the controller is further configured to operate in the active state to unlock the door using the servo motor when data received in response to the request for password information data matches password set-up information data.

19. A method for authorizing secure access control of a locking device over a short-range wireless radio frequency, the method comprising:
inserting a USB key into a user interface of the locking device to transmit an access request;
responsive to the transmitted access request, receiving confirmation that the locking device is configured to establish a connection between the locking device and an intelligent user terminal, and establishing the connection;
transmitting authorization data to the control device through the established connection, said authorization data comprising at least one of a physical address code, an unlock password, and a mobile phone number uniquely identifying the communication module of the intelligent user terminal; and,
processing data related to the authorization status of the intelligent user terminal based on the transmitted authorization data for indicating the intelligent user terminal has been authorized as an authorized user terminal.

20. The method of claim 19, wherein:
transmitting an access request at a user interface comprises pressing a “Wake” button on the locking device and transmitting an indication that a “Match” button has been pressed;
receiving confirmation that the control device is configured to establish a connection further comprises receiving confirmation that the locking device is configured to operate in an energy saving mode, and to operate in an active state initiated by at least one of the operation of the “Wake” button, an instant message, an email, or a phone call transmitted to the controller from the authorized user terminal;
processing data related to the authorization status of the intelligent user terminal comprises:
receiving data identifying the intelligent user terminal as an authorized user terminal when the transmitted uniquely identifying information is determined to have been transmitted from an authorized user terminal;
receiving a data request for an unlock code when the transmitted uniquely identifying information is determined not to have been transmitted from an authorized user terminal;
transmitting data from the intelligent user terminal in response to the data request, wherein the transmitted data comprises unlock passwords and phone numbers related to previous communications with locking devices; and,
receiving data identifying the intelligent user terminal as an authorized user terminal based on the data transmitted in response to the request;
receiving a request for password set-up information data from the locking device;
transmitting data in response to the request;
transmitting password information data to the locking device, wherein the active state is further initiated when data transmitted in response to a request for password set-up information data matches the transmitted password information data; and,
the authorized user terminal receives access log information from the controller.
